(19) United States
(12) Patent Application Publication
(10) Pub. No.: US 2019/0308453 A1
(43) Pub. Date: Oct. 10, 2019

(54) Reinforcing ply for articles made of an elastomeric material, preferably for pneumatic vehicle tyres, and pneumatic vehicle tyre

(71) Applicant: Continental Reifen Deutschland GmbH, Hannover (DE)

(72) Inventors: Wolfgang REESE, Peine (DE); Thomas KRAMER, Herford (DE)

(73) Assignee: Continental Reifen Deutschland GmbH, Hannover (DE)

(21) Appl. No.: 16/307,948

(22) PCT Filed: May 8, 2017
(86) PCT No.: PCT/EP2017/060855

§ 371 Date: Dec. 7, 2018

(30) Foreign Application Priority Data
Jun. 9, 2016 (EP) 16173676.4

(51) Int. Cl. B60C 9/00; B60C 15/06; D07B 1/16

(52) U.S. Cl. CPC B60C 9/0042; B60C 15/0632; B60C 15/0635; D07B 2501/2046; B60C 2015/0689; B60C 2009/0092; B60C 2009/0078; D07B 1/162

(57) ABSTRACT

The invention relates to a rubberized reinforcing ply for articles made of elastomeric material, preferably for vehicle tires, where the reinforcing ply has a multiplicity of parallel strengthening elements spaced apart from one another, with each strengthening element consisting of polyamide 6.6 and having an x1 construction, hence being a twisted multifilament yarn of polyamide 6.6. The crude yarn of polyamide 6.6 has a tenacity which, at an elongation of 4%, is within a range from 1.35 cN/dtex to 1.60 cN/dtex; the multifilament yarn has a tenacity which, at an elongation of 4%, is within a range from 2.0 cN/dtex to 2.8 cN/dtex, and the cord has a thermal shrinkage at 177° within a range of 4.0%-7.0%, wherein the tenacity in accordance with ASTM D885-16 and the thermal shrinkage at 77° C. are determined under a pre-tension of 0.045 g/dtex with an exposure time of two minutes.

The invention relates to a rubberized reinforcing ply for articles made of elastomeric material, preferably for vehicle tires, where the reinforcing ply has a multiplicity of parallel strengthening elements spaced apart from one another, with each strengthening element consisting of polyamide 6.6 and having an x1 construction, hence being a twisted multifilament yarn of polyamide 6.6. The invention further relates to a pneumatic vehicle tire comprising this reinforcing ply.

Reinforcing plies for articles made of elastomeric material such as, for example, industrial rubber products and (pneumatic) vehicle tires are extremely important and are general knowledge to the person skilled in the art. The reinforcing plies have a multiplicity of reinforcing, thread-shaped elements, referred to as the strengthening elements. They are embedded completely in elastomeric material. The strengthening elements of these reinforcing plies have the form, for example, of fabrics or of calendered, continuously coiled strengthening elements.

In the case of pneumatic vehicle tires, multifilament yarns are used as strengthening elements, for example, in the bead region and in the belt bandage.

In pneumatic vehicle tires, and especially in the context of high-speed use, the belt bandage serves to prevent lifting of the tire caused by the centrifugal forces which occur in driving operation. In the case of a pneumatic vehicle tire, which comprises in general an air-impervious inner layer, a radial carcass comprising strengthening elements and extending from the crown of the tire via the sidewalls into the bead region, where it is anchored usually by entwinement of bead cores of high tensile strength, a radially outer tread having profile grooves, and a belt, the bandage is disposed between belt and tread. The belt bandage may be of single-ply or multi-ply construction; it covers at least the belt edges and contains strengthening elements which run parallel and substantially in circumferential direction and which are embedded in a rubber mixture. During tire manufacturing, the belt bandage is applied in the form of plies, strips or individual strengthening elements, with strengthening elements embedded into an unvulcanized rubber mixture, these elements being wound or coiled onto the belt. The strengthening elements for such plies are embedded in rubber such that, for example, an array of substantially parallel, thread-shaped strengthening elements, which in general have been pretreated thermally and/or with impregnation, in a manner known to the person skilled in the art, for better adhesion to the embedding rubber, run in longitudinal direction through a calender or through an extruder for ensheathing with the rubber mixture. An alternative is to use strengthening elements which have been given adhesive impregnation and can be processed without a calendered adhesion mixture. In the shaping and the vulcanization of the tire, the tire stretches in general in the shoulder region, as a result of the lifting, by up to 2%, and in the middle region by up to 4%, in comparison to the unvulcanized green tire when the latter is wound on a flat drum. The strengthening element which is used in the belt bandage is thus supposed advantageously to allow this lifting, in other words to be able to be stretched initially with a relatively low application of force, but after this initial stretch of up to 4% is to be able to be stretched only with greater application of force, for high-speed operability. In a force-elongation diagram, therefore, the strengthening element is to exhibit a relatively flat profile up to an elongation of 4%, and a steeper profile thereafter.

The belt bandage is of single-ply or multi-ply construction, covers the belt edges, and has strengthening elements which extend parallel and approximately in peripheral direction and are embedded in rubber. “Approximately in peripheral direction” refers to an angle of 0° to 5° in relation to the peripheral direction of the tire.

Known from WO 2014182265 A1 is a pneumatic vehicle tire having polyamide 6.6 strengthening elements in the belt bandage.

U.S. Pat. No. 3,343,363 A discloses twisted polyamide 6.6 filaments, yarns, and cords as strengthening elements for use as reinforcing material for tires, these elements having an initial modulus of between 25 and 60 g/d and a tenacity of greater than 7.0 g/d at room temperature. The initial modulus values are determined according to ASTM A1380-61T.

U.S. Pat. No. 3,849,976 A discloses polyamide 6.6 cords having two or more multifilament yarns with an L₅ modulus of greater than 60 g/d as reinforcing material for tires, these yarns being obtained by high-tension stretching at high temperatures.

U.S. Pat. No. 4,284,117 A discloses twisted nylon, polyester, rayon, and aramid yarns as elements strengthening the belt bandage of pneumatic vehicle tires.

It is known practice from the prior art to increase the initial modulus or LASE (Load At Specified Elongation) of polyamide strengthening elements by subjecting them to hot stretching at comparatively high temperatures. In order to retain the resultant properties even after relaxation (conditioned with free cut ends under laboratory conditions), it has hitherto been necessary to expose the PA 6.6 yarns or cords to temperature conditions of higher than 250° C. A disadvantage, however, is that under the above conditions, the yarns or cords become rigid/brittle and therefore undergo fatigue more rapidly on exposure to cycles of compressive stress and bending stress.

It is the object of the invention to provide a reinforcing ply for articles of elastomeric material that has strengthening elements made of polyamide 6.6 with a comparably high modulus from 4% elongation, but which are more fatigue-resistant in relation to cycles of compressive stress and flexural stress. It is the object of the invention, further, to provide a pneumatic vehicle tire which has an aforesaid reinforcing ply and which exhibits improved high-speed properties and improved rolling resistance.

The object is achieved in relation to the reinforcing ply in that the crude yarn of polyamide 6.6 has a tenacity which, at an elongation of 4%, is within a range from 1.35 cN/dtex to 1.60 cN/dtex, in that the twisted, dipped, and hot-stretched multifilament yarn has a tenacity which, at an elongation of 4%, is within a range from 2.0 cN/dtex to 2.8 cN/dtex, and in that the strengthening element has a thermal shrinkage at 177° within a range of 4.0%-7.0%, wherein the tenacity in accordance with ASTM D885-16 and the thermal shrinkage at 177° C. are determined under a pre-tension of 0.045 g/dtex with an exposure time of two minutes.

“Crude yarn” refers to a multifilament yarn which has not yet undergone hot stretching. “Multifilament yarn” refers to a multifilament yarn which is twisted and therefore as a strengthening element has an x1 construction, and which has already undergone the operation of hot stretching, including impregnation.

The reinforcing ply provided has multifilament yarns of polyamide 6.6 which, at an elongation of 4%, have a higher modulus of elasticity than comparable multifilament yarns, but which are more fatigue-resistant in relation to cycles of compressive stress and bending stress. These properties are especially suitable for use of this reinforcing ply in a vehicle tire, more particularly as a belt bandage, since the requisite elongation of up to about 3% is retained for tire manufacture, whereas higher forces have to be applied in the case of greater elongations, this being advantageous for the high-speed operation of the tire.

Surprisingly, the multifilament yarns of polyamide 6.6 for the reinforcing ply of the invention are obtained in that the raw polyamide 6.6 yarn used has a tenacity which, at an elongation of 4%, is within a range from 1.35 cN/dtex to 1.60 cN/dtex and in that this crude yarn is stretched in a range of greater than 5% and less than 12% at temperatures of between 230° C. and 250° C. and is coiled up onto suitable spools with a tension of between 150 g and 500 g per strengthening element. As a result of this, the properties gained through the stretching operation are retained even in the strengthening element wound onto the spool, since the strengthening element is unable to relax and can be used in the tire without the relaxation, which always entails a loss of modulus.

The force-elongation data of the yarns are determined in accordance with D885-16, after the yarns have been conditioned on spools for 24 hours at 24° C. and at a relative atmospheric humidity of 55%. After having been conditioned, the yarns are tested within 1 minute after unwinding from the spool.

These multifilament yarns have a tenacity at 4% elongation of from 2.0 cN/dtex to 2.8 cN/dtex and a thermal shrinkage at 177° C. of from 4% to 7%. The tenacity at 4% elongation of from 2.0 cN/dtex to 2.8 cN/dtex corresponds to a modulus of 51 g/dtex to 71.4 g/dtex (56.7 g/d to 79.3 g/d).

The modulus values are calculated as follows: tenacity at 4% elongation×25, to give the required tenacity for 100% elongation.

The tenacity at 4% elongation [cN/dtex] is: Tensile force at 4% elongation [cN]/linear density [dtex], employing the linear density of the entire strengthening element.

The thermal shrinkage of yarns and cords is determined using a shrinkage measurement device from the manufacturer Testrite under a pre-tension of 0.045 g/dtex at 177° C. with an exposure time of 2 minutes.

It is useful if the raw yarn of polyamide 6.6 has a tenacity which, at an elongation of 4%, is within a range from 1.35 cN/dtex to 1.50 cN/dtex. If the forces were even higher, this could lead to problems during mold introduction.

It is useful if the multifilament yarn has a linear density of from 300 to 4000 dtex. This linear density range represents an advantageous balance between strength on the one hand and rolling resistance and costs on the other. If the linear density were too low, i.e., if the multifilament yarn were too thin, the resulting strength would be too low. If the multifilament yarn were too thick, this would be detrimental to the rolling resistance of the tire and detrimental to the costs.

It is advantageous if the twist factor a of the multifilament yarn is within a range from 30 to 50, preferably within a range from 35 to 45, where α=twist [t/m]·(linear density [tex]/1000)^{1/2}. The twist factor is a measure of the twist per meter of the multifilament yarn, relative to the linear density of the multifilament yarn. This twist factor represents an advantageous balance between fatigue resistance and strength. A lower twist factor would be detrimental to the fatigue resistance; a higher twist factor would denote lower strength on the part of the strengthening element.

In a first particularly suitable embodiment of the invention, the strengthening element of the reinforcing ply is a multifilament yarn having a linear yarn density of 940 dtex, where the yarn has a tenacity which, at an elongation of 4%, is within a range from 2.0 cN/dtex to 2.8 cN/dtex and where the multifilament yarn is arranged in the reinforcing ply preferably in a density of 100 epdm. Because of the increased modulus of the PA6.6 strengthening element in comparison to the prior art, it can be disposed in the reinforcing ply in a lower density, thereby simplifying the production of this ply and likewise achieving a cost advantage because of the reduced use of strengthening elements. There is likewise a lower risk of the semifinished product being damaged during cutting to the required strip width.

In a second particularly suitable embodiment of the invention, the strengthening element of the reinforcing ply is a multifilament yarn having a linear yarn density of 1400, where the yarn has a tenacity which, at an elongation of 4%, is within a range from 2.0 cN/dtex to 2.8 cN/dtex and where the multifilament yarn is arranged in the reinforcing ply preferably in a density of 90 epdm. Because of the increased modulus of the PA6.6 strengthening element in comparison to the prior art, it can be disposed in the reinforcing ply in a lower density, thereby simplifying the production of this ply and likewise achieving a cost advantage because of the reduced use of strengthening elements. There is likewise a lower risk of the semifinished product being damaged during cutting to the required strip width.

It is advantageous if the reinforcing ply is a belt bandage ply, where the strengthening elements are wound in the form of rubberized fabric strips or as rubberized fabric, or is spirally coiled in the form of twisted individual multifilament yarns or as rubberized strips which have a plurality of parallel individual multifilament yarns. The polyamide 6.6 multifilament yarn has physical properties which make it particularly suitable for use in a belt bandage.

Alternatively, however, the reinforcing ply may likewise be a bead reinforcement such as a chipper or flipper.

The invention is achieved in relation to the pneumatic vehicle tire by said tire comprising an above-described rubberized reinforcing ply. The pneumatic vehicle tire has improved rolling resistance and, given suitable density of the strengthening elements in the belt bandage, has improved high-speed performance.

1.-9. (canceled)

10. A rubberized reinforcing ply for articles made of elastomeric material, wherein the reinforcing ply comprises a multiplicity of parallel strengthening elements spaced apart from one another, wherein each strengthening element consists of polyamide 6.6 and has an x1 construction, hence being a twisted multifilament yarn of polyamide 6.6;
wherein a crude yarn of polyamide 6.6 forming the twisted multifilament yarn of polyamide 6.6 has a tenacity which, at an elongation of 4%, is within a range from 1.35 cN/dtex to 1.60 cN/dtex;
wherein the multifilament yarn after twisted, dipped and hot-stretched, has a tenacity which, at an elongation of 4%, is within a range from 2.0 cN/dtex to 2.8 cN/dtex, and wherein the multifilament yarn has a thermal shrinkage at 177° within a range of 4.0%-7.0%; and,
wherein the tenacity, measured in accordance with ASTM D885-16, and the thermal shrinkage at 177° C. are determined under a pre-tension of 0.045 g/dtex with an exposure time of two minutes.

11. The reinforcing ply as claimed in claim 10, wherein the multifilament yarn has a linear density of from 300 to 4000 dtex.

12. The reinforcing ply as claimed in claim 10, wherein a twist factor a of the multifilament yarn is within a range from 35 to 45, and wherein α=twist [t/m]·(linear density [tex]/1000)^{1/2} .

13. The reinforcing ply as claimed in claim 10, wherein the raw yarn of polyamide 6.6 has a tenacity which, at an elongation of 4%, is within a range from 1.35 cN/dtex to 1.50 cN/dtex.

14. The reinforcing ply as claimed in claim 13, wherein the multifilament yarn has a linear yarn density of 940 dtex, in that the yarn has a tenacity which, at an elongation of 4%, is within a range from 2.0 cN/dtex to 2.8 cN/dtex, and wherein the multifilament yarn is arranged in the reinforcing ply in a density of up to 210 epdm.

15. The reinforcing ply as claimed in claim 13, wherein the multifilament yarn has a linear yarn density of 1400 dtex, wherein the yarn has a tenacity which, at an elongation of 4%, is within a range from 2.0 cN/dtex to 2.8 cN/dtex, and wherein the multifilament yarn is arranged in the reinforcing ply in a density of up to 180 epdm.

16. The reinforcing ply as claimed in claim 10, wherein the multifilament yarn has a thermal shrinkage at 177° in a range of 5.0%-6.5%.

17. The reinforcing ply as claimed in claim 10, wherein the reinforcing ply is a bead reinforcement such as a chipper or flipper.

18. A pneumatic vehicle tire which has a reinforcing ply as claimed in claim 10.
